(19) United States
(12) Patent Application Publication
(10) Pub. No.: US 2005/0201701 A1
(43) Pub. Date: Sep. 15, 2005

(54) Optical collimator for monomode fiber having a graded-index fiber section, corresponding monomode fiber with extended core and method for making same

(75) Inventor: Philippe Chanclou, Lannion (FR)

Correspondence Address: MERCHANT & GOULD PC, P.O. BOX 2903, MINNEAPOLIS, MN, 55402-0903, US

(73) Assignee: OTOGONE SA, Plouzane (FR)

(21) Appl. No.: 10/509,789

(22) PCT Filed: Apr. 3, 2003
(86) PCT No.: PCT/FR03/01056

§ 371 Date: Apr. 25, 2005

(30) Foreign Application Priority Data
Apr. 8, 2002 (FR) 02/04366

(51) Int. Cl. G02B 6/18

(52) U.S. Cl. 385/124

(57) ABSTRACT

The invention relates to a monomode fibre optical collimator, comprising at least one segment of mode expansion fibre, and at least one segment of expansion holding fibre comprising at least a first segment of graded index multimode fibre. The invention also relates to a monomode fibre comprising at its end such an optical collimator, along with the corresponding production method.

The field of the invention is that of telecommunications, and more specifically that of optical fibre telecommunications.

More specifically, the invention relates to an optical collimator intended to be positioned at the end of a monomode optical fibre, so as to expand the cross-section of the light beam carried by said monomode fibre.

Actually, in the field of telecommunications, the monomode optical fibre represents the most popular transmission medium for high-speed data transmission over long distances. However, the use of this fibre, in spite of its beneficial propagation properties, results in significant assembly difficulties when the interconnection of two fibres is required.

These difficulties are essentially due to the small emission surface area of said monomode fibres, typically of the order of 10 μm in diameter. This small size renders the optical coupling of a monomode fibre with any other optical component (including another monomode fibre) very sensitive to the relative axial and transversal positions of the fibre and the component.

In addition, this coupling is also very sensitive to the presence of any dust in the atmosphere surrounding the ends of the components to be interconnected, as well as to any end defect of the monomode fibre.

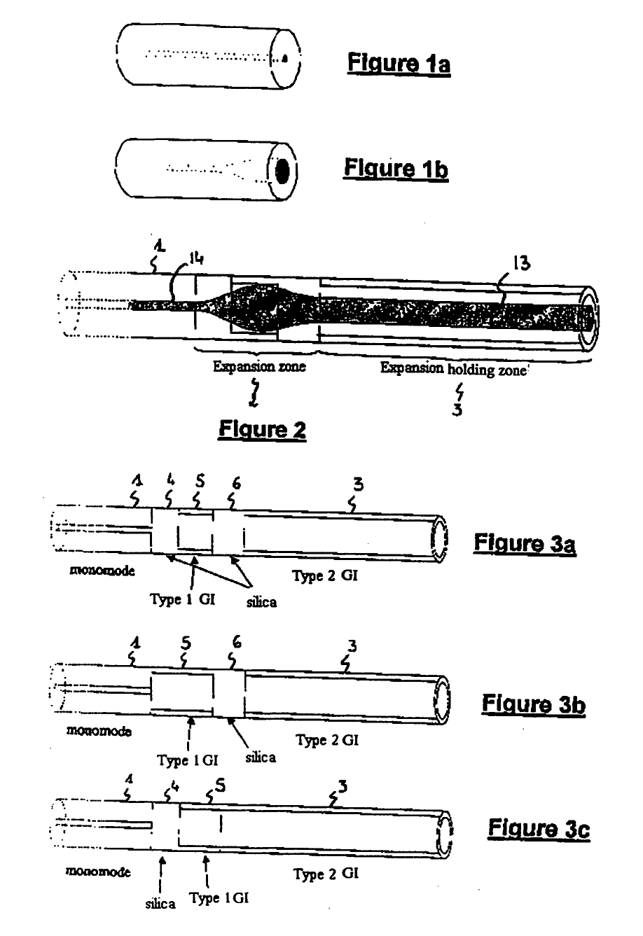

Therefore, optical collimators for monomode fibres offer particular benefits, since they make it possible to enlarge the size of the light beam propagated in the monomode fibre. FIGS. 1a and 1b show, along dotted lines, the shape of the optical beam in the case, respectively, of a conventional monomode fibre and a monomode fibre comprising an optical collimator at its end, so as to expand the cross-section of the beam at the fibre output.

In this way, such optical collimators make it possible, when coupling a monomode fibre with any other optical component, to reduce positioning constraints and the influence of dust or surface defects on the effectiveness of the optical coupling produced.

In addition, collimation makes it possible to reduce the divergence of the optical beam at the monomode fibre output.

Several techniques used to produce such optical collimators at the end of a monomode fibre are known to date.

A first technique consists of using discrete Selfoc (registered trademark) type lenses, positioned at the monomode fibre output.

A drawback of this first technique according to the prior art is that this solution is not integrated at the end of the monomode fibre. In fact, the diameter of a Selfoc type lens is conventionally of the order of one millimetre, while the external diameter of a monomode fibre is generally 125 μm. Therefore, this solution is not optimal in terms of compact size and packaging.

A second known technique consists of expanding the mode of the monomode fibre, by thermal diffusion of dopants from the core of the monomode fibre, so as to produce a TEC (“Thermally diffused Expanded Core”) type monomode fibre. This solution offers the advantage of enabling an increase in the cross-section of the optical beam carried by the fibre, while keeping the external diameter of the fibre constant, equal to 125 μm.

However, a drawback of this technique according to the prior art is that the expansion zone of the beam formed in this way is of a specified length, defined according to the optical properties of the fibre to be produced. This limitation in the length of the beam expansion zone reduces the possibilities of carrying out modelling operations on the end of the fibre, such as for example polishing operations, cleaving of the fibre at an angle, which are basic steps of fibre connectorisation.

Therefore, these fibres cannot benefit from the connectorisation technology generally used for standard monomode fibres.

A third technique, particularly described in the French patent No. FR 2 752 623, entitled “collective optical coupling device production method and device obtained by means of such a method”, consists of producing lenses at the fibre end, so as to obtain a Gradissimo (registered trademark) type fibre. Such a monomode fibre comprises at its end a segment of pure silica fibre, followed by a segment of graded index multimode fibre, so as to produce an optical beam expansion zone.

This third technique involves the same drawback as that of TEC fibres, i.e. that the beam expansion zone is of limited length, and does not enable the use of such a fibre to carry out splitting, polishing operations at an angle or for the insertion thereof into a connector.

A fourth technique consists of devising a fibre comprising at its end a diffractive lens. Such a diffractive lens is for example produced by means of photo-inscription at the end of a silica bar, in turn soldered to the monomode fibre.

A drawback of this fourth technique according to the prior art is that it requires precise alignment of the photo-inscription mask and the end of the optical fibre, rendering any collective fibre production difficult.

Another drawback of this technique according to the prior art is that, as for the second and third techniques mentioned above, the fibre equipped with such a diffractive lens cannot be polished or cleaved without destroying the lens. Therefore, the connectorisation of such a fibre is practically impossible.

The invention particularly aims to remedy these drawbacks of the prior art.

More specifically, an aim of the invention is to provide a technique making it possible to carry out an integrated collimation function at the end of an optical fibre.

Another aim of the invention is to implement such a collimation function which does not modify the external appearance of the optical fibre, particularly its external diameter and its solidity.

The invention also aims to provide such a technique making it possible to obtain a monomode optical fibre comprising at its end an expanded beam section with respect to conventional monomode fibres.

The invention also aims to provide such a monomode fibre with an integrated collimator, which is adapted to the execution of end operations, such as cleaving or polishing operations, without impairing the integrated collimation function.

These aims, along with others which will emerge below, are achieved using a production method of at least one expanded mode monomode optical fibre.

According to the invention, such a method comprises the following successive steps:
an assembly step of at least one graded index multimode fibre with at least one mode expansion monomode fibre;
a splitting step of said graded index multimode fibre, so as to obtain a first segment of graded index multimode fibre of predetermined length.

In this way, the invention is based on an entirely novel and inventive approach to the production of a collimation function of a beam carried via optical fibre. In effect, the invention particularly consists of soldering and cleaving, at the end of a mode expansion monomode fibre, a graded index multimode fibre, so as to produce an integrated collimation function at the end of the monomode fibre. Therefore, the device formed in this way offers, with respect to the techniques according to the prior art, advantages in terms of compact size and simple assembly.

The segment of graded index multimode fibre carries out a function consisting of holding the expanded optical beam section, which advantageously makes it possible to carry out end operations (such as cleaving, polishing, etc.) without impairing the collimation function, unlike the known techniques according to the prior art.

Preferentially, said mode expansion monomode fibre comprises a monomode fibre, at least one segment of silica fibre, and at least a second segment of graded index multimode fibre.

The invention also relates to a production method of at least one expanded core monomode optical fibre, comprising the following successive steps:
a first assembly step of a first graded index fibre with a first silica fibre;
a first splitting step of said first silica fibre, so as to obtain a first segment of silica fibre of predetermined length;
a second assembly step of a second graded index fibre at the free end of said first segment of silica fibre;
a second splitting step of said second graded index fibre, so as to obtain a segment of graded index fibre of predetermined length, referred to as the second segment of graded index fibre;
a third assembly step of a second silica fibre at the free end of said second segment of graded index fibre;
a third splitting step of said second silica fibre, so as to obtain a second segment of silica fibre of predetermined length;
a fourth assembly step of a monomode fibre at the free end of said second segment of silica fibre, so as to obtain an expanded core monomode optical fibre.

Advantageously, such a method also comprises a splitting step of said first graded index fibre, so as to obtain a first segment of graded index fibre.

According to a first preferential alternative embodiment of the invention, said first and second segments of graded index fibre are of the same type.

According to a second preferential alternative embodiment of the invention, said first and second segments of graded index fibre are of different types.

According to an advantageous characteristic of the invention, such a method uses ribbons of n fibres, so as to produce a set of n expanded core monomode optical fibres collectively.

According to an advantageous characteristic of the invention, such a method comprises a geometric modelling step of the free end of said first segment of graded index fibre.

According to a first alternative embodiment of the invention, said geometric modelling step consists of straight cleaving and/or straight polishing of said end.

According to a second alternative embodiment of the invention, said geometric modelling step consists of cleaving at an angle and/or polishing at an angle of said end.

According to a third alternative embodiment of the invention, said geometric modelling step is used to round said end, so as to form a lens.

Preferentially, said end is rounded using any of the techniques belonging to the group comprising:
melting;
drawing;
material addition.

According to a fourth alternative embodiment of the invention, said geometric modelling step consists of etching said end using any of the techniques belonging to the group comprising:
chemical etching;
mechanical etching by polishing;
laser etching.

The invention also relates to a monomode fibre optical collimator, comprising at least one segment of mode expansion fibre, and at least one segment of expansion holding fibre comprising at least a first segment of graded index multimode fibre.

Advantageously, said segments of mode expansion and expansion holding fibre have the same diameter as said monomode fibre.

Preferentially, said segment of mode expansion fibre comprises at least one segment of silica fibre and at least a second segment of graded index multimode fibre.

According to an advantageous characteristic of the invention, said segment of mode expansion fibre consists of two segments of silica fibre, between which said second segment of graded index multimode fibre is inserted.

In an alternative embodiment of the invention, said first and second segments of graded index multimode fibre are of the same type. The first and second segments of graded index fibre may of course also be of different types.

According to a first alternative embodiment, one end of said first segment of graded index multimode fibre is split and/or polished straight.

According to a second alternative embodiment, one end of said first segment of graded index multimode fibre is split and/or polished at an angle.

According to a third alternative embodiment, one end of said first segment of graded index multimode fibre is rounded.

Preferentially, said end is rounded using any of the techniques belonging to the group comprising:
melting;
drawing;
material addition.

According to a fourth embodiment, one end of said first segment of graded index multimode fibre is modelled using any of the techniques belonging to the group comprising:
chemical etching;
mechanical etching by polishing;
laser etching.

The invention also relates to an expanded mode diameter monomode optical fibre, comprising at its end at least one mode expansion section and at least one expansion holding section comprising at least a first segment of graded index multimode fibre.

Advantageously, said mode expansion section comprises at least one segment of silica fibre and at least a second segment of graded index multimode fibre.

Preferentially, said mode expansion section comprises two segments of silica fibre between which said second segment of graded index multimode fibre is inserted.

According to an advantageous characteristic of the invention, said monomode fibre, said mode expansion section and said expansion holding section have the same diameter.

Advantageously, said monomode fibre is of the polarisation holding type.

Other characteristics and advantages of the invention will emerge more clearly on reading the description below of a preferential embodiment, given simply as an illustrative and non-limitative example, and the appended figures, wherein:

FIGS. 1a and 1b, already described above, respectively illustrate the shape of the optical beam carried by a conventional monomode optical fibre and by a monomode optical fibre with a collimation function;

FIG. 2 shows a block diagram of a monomode optical fibre with an integrated collimator according to the invention;

FIGS. 3a to 3c illustrate different alternative embodiments of the monomode fibre in FIG. 2, and more specifically different alternative embodiments of the expansion zone of such a fibre;

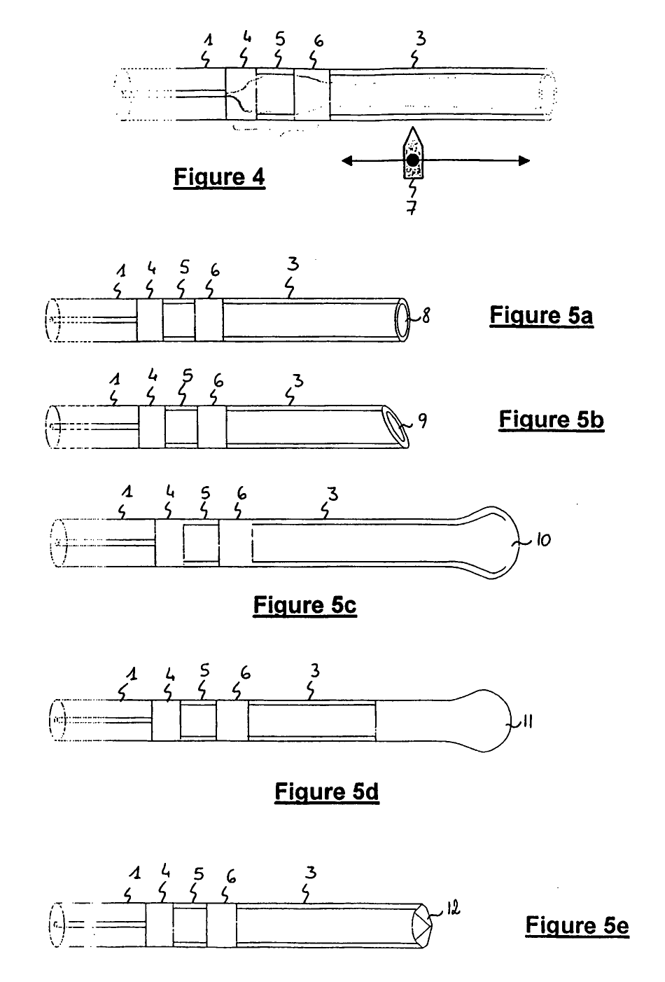

FIG. 4 relates to the execution of an end operation on the monomode fibre in FIG. 2;

FIGS. 5a to 5e show the different possible geometric shapes of the end of the monomode fibre in FIG. 2, resulting from the end operation in FIG. 4.

The general principle of the invention is based on the production of a monomode fibre with an integrated collimation function, by assembling and soldering sections of graded index fibres and silica fibres of defined lengths.

FIG. 2 shows an embodiment of a monomode fibre 1 according to the invention comprising at its end an integrated collimation function.

The device in FIG. 2 makes it possible to obtain at the end of the monomode fibre 1 a wider mode diameter 13 than that 14 of the monomode fibre 1, while retaining a constant external diameter, equal to that of the monomode fibre 1, or conventionally 125 μm.

Such a device comprises an expansion zone of the optical beam 2 and an expansion maintenance (or holding) zone 3 of the beam from the monomode fibre 1.

The expansion zone 2 makes it possible to increase the size of the optical beam, while the expansion holding zone 3 makes it possible to keep this expanded beam size roughly constant. This property of the expansion holding zone 3, made of graded index fibre, makes it possible to carry out end operations, such as for example a cleaving or polishing operation, at any point of the expansion holding zone 3. The expansion zone 2 of the beam is thus protected from the end operations. These aspects will be described in more detail hereafter with reference to FIGS. 4 and 5.

The device in FIG. 2, which makes it possible to expand and maintain the mode of a monomode fibre 1, is produced by assembling and soldering juxtaposed sections of fibres of different types. The expansion 2 and expansion holding zones 3 comprise sections of the following fibres:
pure silica: such a fibre is characterised in that it does not have a light guiding index profile. It consists only of silica and conventionally has an external diameter of 125 μm;
graded index: such a fibre comprises an optical core wherein the index profile is parabolic from the centre to the periphery. Such an index profile is obtained by doping silica. The external diameter of the fibre is conventionally equal to 125 μm, and the core diameter is generally between 125 μm and 1 μm.

FIGS. 3a to 3c show the different silica and graded index fibre section arrangement configurations envisaged within the scope of the invention.

According to the embodiment in FIG. 3a, the invention consists of soldering, at the end of a monomode optical fibre 1, a first section 4 of silica fibre, followed by a first section 5 of graded index fibre, followed by a second section 6 of silica fibre, followed by a second section 3 of graded index fibre, acting as the expansion holding zone.

FIGS. 3b and 3c show simplified alternative embodiments with reference to the configuration in FIG. 3a.

In this way, according to the configuration in FIG. 3b, the collimation function is produced by soldering, at the end of the monomode fibre 1, a first segment of graded index fibre 5, followed by a segment of silica fibre 6, followed by a second segment of graded index fibre 3 producing the expansion holding zone.

According to the configuration 3c, on the other hand, the monomode fibre 1 comprises at its end a segment of silica fibre 4, to which a first segment of graded index fibre 5 is soldered, which is in turn soldered to a second segment of graded index fibre 3 acting as the optical beam expansion holding zone.

In the three configurations shown with reference to FIGS. 3a to 3c, the segments of graded index fibres referenced 5 and 3, belonging respectively to the expansion zone 2 and the expansion holding zone, may be of the same type or of different types. In this way, these two segments may or may not have the same index profile and/or the same core diameter.

The expanded beam monomode fibre device in FIGS. 2 and 3a are produced according to the invention using the following production steps:
firstly, the end of a first graded index fibre referenced 3 is assembled with a first pure silica fibre;
the first silica fibre is then split so as to produce a first segment 6 of pure silica fibre;
the assembly comprising the first graded index fibre 3 and the first segment of silica fibre 6 is then assembled, via the free end of the first segment 6 of silica fibre, with a second graded index fibre 5, which may or may not be of the same type as the first graded index fibre 3;
the second graded index fibre 5 is then split so as to produce a second segment of graded index fibre;
at the free end of said second graded index segment 5, a second pure silica fibre 4 is assembled;
the second pure silica fibre 4 is split so as to produce a second segment of pure silica fibre;
the assembly formed from the first and second segments of silica fibres 4 and 6 and the first and second segments of graded index fibres 5 and 3 is assembled with a monomode fibre 1.

The cleaving operations listed above consist of cleaving a section of fibre with precision by viewing the solder seam.

This gives a monomode fibre 1, comprising at its end an integrated optical collimator.

Naturally, this production method may also be used simultaneously on a plurality of fibres arranged in the form of ribbons of n fibres. In this way, the soldering and cleaving operations described above are carried out simultaneously on a number of optical fibres that can vary from 1 to n.

In addition, it is important to note that, according to the invention, it may be advantageous to use a polarisation holding monomode fibre 1.

The end of the device in FIGS. 2 and 3 may be processed so as to show various geometric shapes, as illustrated with reference to FIGS. 4 and 5. The presence, at the end of the device according to the invention, of an expansion holding zone 3 makes it possible to carry out an end operation at any point of the end graded index fibre, as illustrated by the arrow 7 in FIG. 4. In fact, the cross-section of the optical beam is maintained in expanded form throughout the expansion holding zone 3, such that the location of the end of the optical device does not modify the size of the optical beam.

In this way, various end operations, illustrated by FIGS. 5a to 5e may be performed on the graded index fibre 3 which holds the expanded optical beam.

According to the alternative embodiment in FIG. 5a, the end graded index fibre 3 may be cleaved and/or polished straight. Such a configuration enables straight polishing 8 of the fibre without affecting the graded index section and therefore the mode expansion.

According to the alternative embodiment in FIG. 5b, the end graded index fibre 3 may be cleaved and/or polished at an angle. This gives an angled end 9 without affecting the graded index and therefore the mode expansion.

FIGS. 5c and 5d illustrate the case wherein the end of the graded index fibre 3 is rounded, for example by melting, drawing or adding material, so as to obtain an end lens 10, 11.

Finally, it is possible to obtain any geometric shape at the end 12 of the graded index fibre 3, as illustrated in FIG. 5e, when the graded index fibre 3 is etched chemically or mechanically by polishing or laser.

The operating principle of the device according to the invention described above with reference to FIGS. 2 to 5, is detailed briefly below.

First of all, a brief description is given on the operating principle of the expansion zone 2 of the optical beam, comprising a segment of graded index fibre and one or two segments of silica fibre.

It is important to note that in an graded index multimode fibre, the beams are propagated periodically along the optical axis of the fibre. This is due to successive lateral refractions undergone by the electromagnetic wave when it is propagated in an index medium which declines from the centre of the fibre to the periphery. The period depends firstly on the index profile of the fibre, which observes a parabolic law, and secondly the wavelength of the light propagated therein.

When a segment of graded index multimode fibre is cut, a lens is obtained, wherein the properties depend on the length L of the segment, the index profile and the length of the wave propagated therein. Said graded index 5 of the expansion zone 2 is therefore equivalent to a conventional plane-plane graded index lens.

The silica segments 4 and 6, of defined length, play a dual role: they make it possible for the silica segment 4 (or for the silica segment 6) to position the monomode fibre 1 (or the end graded index fibre 3) at the optimum distance with reference to the graded index lens 5, while retaining a practically constant index in the optical path. In addition, they provide the physical connection between the different sections of fibre of the device according to the invention, without modifying the external diameter.

The operating principle of the expansion holding zone 3 of the device according to the invention will now be described.

The optical beam expanded by the optical system 2, consisting of sections of pure silica 4 and 6 and graded index fibres 5, is injected into another graded index fibre 3. This fibre 3 is used to guide the expanded beam without modifying its optical properties over a certain distance. This propagation condition in the graded index 3 corresponds to the properties of the mode LP01 of the graded index fibre.

The optical system 2, consisting of sections of pure silica and graded index fibres, is devised so as to optimise the coupling of the expanded beam with the mode LP01 of the end graded index fibre 3.

In the end graded index fibre 3, propagation of a mode LP01 is possible over a certain distance. This mode has the property of being wider than in the monomode fibre 1. The propagation of said mode is not accompanied by any variation of the geometry of the optical beam (i.e. the mode diameter). The excitation of said mode, and only of this mode, is conditioned by the quality of the injection of the optical beam from the expansion optics 2 to said end graded index fibre 3.

It is important to note that, in graded index fibres, other propagation modes exist and that these modes may exchange energy with each other. In fact, from a certain length of said fibres or in the event of strain applied to the graded index fibre 3, the propagation method may be impaired and may exchange power with other propagation modes LPxy. These modes do not have a Gaussian speed and it will not be possible to couple them in a monomode fibre 1 without involving significant losses. Within the scope of the invention, it is preferential to be in a situation wherein it is possible to maintain the propagation of the mode LP01 only.

In this way, in said graded index multimode end fibre 3, the size of the optical beam is constant. As indicated above, it is then possible to perform cleaving, polishing operations, etc. at any point of the fibre 3 while retaining an identical beam size. The expansion optics 2 are thus protected and at a distance from the preparation site of the end of the fibre 3 which is involved in expansion holding.

Therefore, in sum, the device according to the invention makes it possible to obtain expansion of the optical beam at the end of a monomode fibre 1. Said expansion of the optical beam is maintained over a certain length of fibre 3, which may undergo standard cleaving, polishing operations and other treatments.

The device according to the invention, consisting of a monomode fibre comprising at its end an integrated collimator described above has numerous applications, in particular:
the production of assemblies of n superimposed fibre components;
the production of very position-tolerant fibre connectors;
the simplification of a more complex assembly of a fibre with other optical components;
the production of wide-beam connectors (i.e. wide-mode), particularly intended for dirty environments (presence of dust, gas, etc.)
the production of contactless connectors for contaminated environments;
the production of interconnection fibres with passive or active discrete components (such as isolators, circulators, polarisers, modulators, filters, liquid crystals, photodiodes, etc.);
the production of coupling fibres with lasers, particularly of the VCSELS (“vertical cavity surface emitting laser”) type;
the production of interconnection fibres with other types of monomode or multiple fibres.

1. Production method of at least one expanded core monomode optical fibre, characterised in that wherein it comprises the following successive steps:
assembly of at least one graded index multimode fibre with at least one mode expansion monomode fibre, such that said graded index multimode fibre retains the diameter of the optical beam propagated therein;
splitting of said graded index multimode fibre to form a protective component of predetermined length of said mode expansion monomode fibre.

2. Production method according to claim 1, wherein said mode expansion monomode fibre comprises a monomode fibre, at least one segment of silica fibre, and at least a second segment of graded index multimode fibre.

3. Production method of at least one expanded core monomode optical fibre, wherein it comprises the following successive steps:
a first assembly step of a first graded index fibre with a first silica fibre;
a first splitting step of said first silica fibre, so as to obtain a first segment of silica fibre of predetermined length;
a second assembly step of a second graded index fibre at the free end of said first segment of silica fibre;
a second splitting step of said second graded index fibre, so as to obtain a segment of graded index fibre of predetermined length, referred to as the second segment of graded index fibre;
a third assembly step of a second silica fibre at the free end of said second segment of graded index fibre;
a third splitting step of said second silica fibre, so as to obtain a second segment of silica fibre of predetermined length;
a fourth assembly step of a monomode fibre at the free end of said second segment of silica fibre, so as to obtain an expanded core monomode optical fibre.

4. Production method according to claim 3, wherein it also comprises a splitting step of said first graded index fibre, so as to obtain a first segment of graded index fibre.

5. Production method according to claim 4, wherein said first and second segments of graded index fibre are of the same type.

6. Production method according to claim 4, wherein said first and second segments of graded index fibre are of different types.

7. Production method according to claim 1, wherein it uses ribbons of n fibres, so as to produce a set of n expanded core monomode optical fibres collectively.

8. Production method according to claim 1, wherein it comprises a geometric modelling step of the free end of said first segment of graded index fibre.

9. Production method according to claim 8, wherein said geometric modelling step consists of straight cleaving and/or straight polishing of said end.

10. Production method according to claim 8, wherein said geometric modelling step consists of cleaving at an angle and/or polishing at an angle of said end.

11. Production method according to claim 8, wherein said geometric modelling step is used to round said end, so as to form a lens.

12. Production method according to claim 11, wherein said end is rounded using any of the techniques belonging to the group comprising:
melting;
drawing;
material addition.

13. Production method according to claim 8, wherein said geometric modelling step consists of etching said end using any of the techniques belonging to the group comprising:
chemical etching;
mechanical etching by polishing;
laser etching.

14. Optical monomode fibre collimator, wherein it comprises at least one segment of mode expansion fibre, and at least one segment of expansion holding fibre comprising at least a first segment of graded index multimode fibre.

15. Optical collimator according to claim 14, wherein said segments of mode expansion and expansion holding fibre have the same diameter as said monomode fibre.

16. Optical collimator according to claim 14, wherein said segment of mode expansion fibre comprises at least one segment of silica fibre and at least a second segment of graded index multimode fibre.

17. Optical collimator according to claim 16, wherein said segment of mode expansion fibre consists of two segments of silica fibre, between which said second segment of graded index multimode fibre is inserted.

18. Optical collimator according to claim 14, wherein one end of said first segment of graded index multimode fibre is cleaved and/or polished straight.

19. Optical collimator according to claim 14, wherein one end of said first segment of graded index multimode fibre is cleaved and/or polished at an angle.

20. Optical collimator according to claim 14, wherein one end of said first segment of graded index multimode fibre is rounded.

21. Optical collimator according to claim 20, wherein said end is rounded using any of the techniques belonging to the group comprising:
melting;
drawing;
material addition.

22. Optical collimator according to claim 14, wherein one end of said first segment of graded index multimode fibre is modelled using any of the techniques belonging to the group comprising:
chemical etching;
mechanical etching by polishing;
laser etching.

23. Expanded mode diameter monomode optical fibre, wherein it comprises at its end at least one mode expansion section and at least one expansion holding section comprising at least a first segment of graded index multimode fibre forming a protective component of predetermined length of said mode expansion section, said expansion holding section retaining the diameter of the optical beam propagated therein.

24. Monomode optical fibre according to claim 23, wherein said mode expansion section comprises at least one segment of silica fibre and at least a second segment of graded index multimode fibre.

25. Monomode optical fibre according to claim 24, wherein said mode expansion section comprises two segments of silica fibre between which said second segment of graded index multimode fibre is inserted.

26. Monomode optical fibre according to claim 23, wherein said monomode fibre, said mode expansion section and said expansion holding section have the same diameter.

27. Monomode optical fibre according to claim 23, wherein said monomode fibre is of the polarisation holding type.
